(19) United States
(12) Patent Application Publication
(10) Pub. No.: US 2012/0273367 A1
(43) Pub. Date: Nov. 1, 2012

(54) WATER PURIFICATION SYSTEMS AND METHODS

(76) Inventors: Constantinos Dean Themy, Missouri City, TX (US); Thomas P. Geoca, Spring, TX (US)

(21) Appl. No.: 13/505,021

(22) PCT Filed: Nov. 1, 2010
(86) PCT No.: PCT/US10/54980

§ 371 Date: Jul. 19, 2012

Related U.S. Application Data
(60) Provisional application No. 61/298,975, filed on Jan. 28, 2010.
(60) Provisional application No. 61/298,967, filed on Jan. 28, 2010.
(60) Provisional application No. 61/298,962, filed on Jan. 28, 2010.
(60) Provisional application No. 61/256,403, filed on Oct. 30, 2009.

(51) Int. Cl. C25B 9/12; C25B 15/04; C02F 1/467

(52) U.S. Cl. 205/756; 204/275.1; 204/277

(57) ABSTRACT

A water purification system includes at least one flow electrolysis cell Each cell comprising an input for receiving wastewater, a cathode, a non-sacrificial anode, and an output for outputting purified water. The non-sacrificial anode is capable of being operated at an input power of at least about, 1000 W up to about 5000 W to form electrooxidation cocktail, and the electrooxidation cocktail treats the wastewater to form purified water.

### RELATED APPLICATIONS

This application claims the benefit of U.S. Provisional Application No. 61/256,403 of Themy, filed on Oct. 30, 2009; U.S. Provisional Application No. 61/298,962 of Themy et al., filed on Jan. 28, 2010; U.S. Provisional Application No. 61/298,967 of Themy et al., flied on Jan. 28, 2010; and U.S. Provisional Application No. 61/298,975 of Themy et al., filed on Jan. 28, 2010, which are incorporated herein by reference.

### STATEMENT REGARDING FEDERALLY SPONSORED RESEARCH

Not applicable.

### FIELD OF THE INVENTION

This invention relates to water purification systems and methods. More particularly, water purification systems and methods utilizing continuous flow high current electrooxidation.

### BACKGROUND

Electrolytic generation of chlorine from brine solutions is conducted using an applied anode voltage of about 3.5 to about 7 volts. Ozone is concurrently produced with the chlorine. As the voltage increases, the rate of chlorine production becomes higher. However, most anodes have an operational limitation of 10-12 volts due to damage that occurs to the electrodes at higher operating voltages. Although some electrodes may be operated at high voltages (i.e., >12 volts) for short periods of time, pitting and catastrophic damage resulting in failure of the electrode soon occurs. Further, some electrodes are sacrificial and have to be replaced at certain intervals.

Various sacrificial electrodes and methods for producing sacrificial electrodes are known in the art. However, for large scale and continuous operation of a high current electrooxidation system needed for wastewater purification as described herein, the ability to run for much longer periods of time at even higher voltages is needed. Continuous high current electrooxidation may be desired in a variety of water purification systems. Hence, it is desirable to utilize electrodes that are non-sacrificial. As used herein, electrodes (particularly the anode) which are capable of being operated continuously at high voltages (>12 V) for extended periods of time will be referred to as non-sacrificial anodes.

Above about 10 V and particularly above about 14 V, a change in the electrolysis of brine solutions takes place, resulting in the generation of free radicals and other charged ionic species. For example, chlorine radicals (monatomic chlorine) and hydroxyl radicals may be produced in addition to the aforementioned ozone and chlorine. Hydrogen peroxide, hypochlorite, and, depending on the pH, hypochlorous acid may also be produced. One of ordinary, skill in the art will recognize the high oxidizing power of these agents. The ability to continuously produce these species would be of considerable benefit in the art to take advantage of their oxidizing power.

### SUMMARY

In one embodiment, a water purification system includes at least one flow electrolysis cell. Each cell comprising an input for receiving wastewater, a cathode, a non-sacrificial anode, and an output for outputting purified water. The non-sacrificial anode is capable of being operated at an input power of at least about 1000 W to about 5000 W to form electrooxidation cocktail, and the electrooxidation cocktail treats the wastewater to form purified water.

In another embodiment, a method for purifying water includes providing wastewater to at least one flow electrolysis cell, and electrolyzing the wastewater using the flow electrolysis cell. The flow electrolysis cell comprising a cathode and a non-sacrificial anode. The non-sacrificial anode is operated at an input power of at least about 1000 W to about 5000 W to form an electrooxidatiorn cocktail. Purified water is outputted from the flow electrolysis cell.

The foregoing has outlined rather broadly various features of the present disclosure in order that the detailed description that follows may be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1A is an illustrative embodiment of a flow electrolysis cell;

FIG. 1B is an illustrative embodiment of a water purification system containing multiple flow electrolysis cells linked in parallel;

FIG. 1C is an illustrative embodiment of water purification system for water purification following hydraulic fracturing of an oil well;

FIG. 2A is an illustrative embodiment of a water purification system containing four flow electrolysis cells linked in parallel in which each cell is coupled to an air injection system;

FIG. 2B is an illustrative embodiment of a water purification system, that is coupled to an air injection system, containing four flow electrolysis cells linked to wastewater input and output;

FIG. 3 is an illustrative embodiment of a multi-anode flow electrolysis cell;

FIG. 4 is an illustrative embodiment of a flow electrolysis cell having a scraper in movable contact with cathode;

FIGS. 5A-D are illustrative embodiments of results for metal before wastewater treatment and after one or more treatments;

FIGS. 6A-C are illustrative embodiments of results for ammonia analysis, chemical oxygen demand, total suspended solids, phosphate and biological oxygen demand before treatment and after one or more treatments; and

FIG. 7 is an illustrative embodiment of a chart summarizing analytical results of a wastewater sample.

### DETAILED DESCRIPTION

In the following description, certain details are set forth such as specific quantities, concentrations, sizes, etc. so as to provide a thorough understanding of the various embodiments disclosed herein. However, it will be apparent to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing particular embodiments of the disclosure and are not intended to be limiting thereto. Furthermore, drawings are not necessarily to scale.

While most of the terms used herein will be recognizable to those of ordinary skill in the art, it should be understood that when not explicitly defined, terms should be interpreted as adopting a meaning presently accepted by those of ordinary skill in the art.

As used herein, the term “brine” refers to, for example, an aqueous salt solution. For example, brine may refer to an aqueous sodium chloride solution, but other aqueous salt solutions are encompassed in other embodiments. In some cases, brine may be considered to have a salt concentration of about or greater 35,000 ppm. However, as discussed herein, brine will be considered to be any salt solution having a salt concentration greater than about 100 ppm.

As used herein, the term “wastewater” refers to, for example, a water source of any type polluted by at least one contaminant. Such contaminants may include, for example, organic compounds, inorganic compounds, heavy metals, biologics and combinations thereof.

As used herein, the term “purified water” refers to wastewater that has been treated by at least a portion of a water purification system or method. For example, purified water may be utilized to describe water that has passed through a flow electrolysis cells or water that has passed through an entire water purification system.

The water purification systems and methods described herein may generally provide flow electrolysis cells. The flow electrolysis cells may include at least one non-sacrificial anode, a cathode, an inlet port, and an outlet port. The non-sacrificial anode produces an electrooxidation cocktail including at least ozone, hypochlorite, hydroxyl radicals and hydrogen peroxide upon electrolysis of an aqueous brine solution. The electrooxidation cocktail may react with contaminants in wastewater, thereby assisting in the removal of contaminants as discussed herein.

Various non-sacrificial electrodes and methods for producing non-sacrificial electrodes are disclosed in U.S. Pat. Nos. 3,443,055 to Gwynn et al., 3,479,275 to Gwynn et al., 3,547,600 to Gwynn et al., 3,616,355 to Themy et al., 4,201,651 to Themy, 4,316,787 to Themy, and 4,236,992 (hereinafter, '992) to Themy. The '992 patent to Themy discloses an electrode capable of being operated continuously at greater than about 20 volts for at least two days. These non-sacrificial electrodes may be suitable use in water purification systems and methods discussed herein.

In some embodiments, water purification systems may have at least one flow electrolysis cell in which each cell has a cathode and at least one non-sacrificial anode. The water purification systems may also include an air injection system coupled to each flow electrolysis cell.

In another embodiment, the flow electrolysis cells may include one or more non-sacrificial anodes, a adjustable cathode located between the at least two non-sacrificial anodes, an inlet port and an outlet port. A distance between the adjustable cathode and the non-sacrificial anodes is adjustable by varying a thickness of the adjustable cathode.

In yet another embodiments, the flow electrolysis cells include at least one non-sacrificial anode, a cathode, an inlet port, an outlet port, and a mechanical scraper in movable contact with the cathode. In other embodiments, the water purification systems may also include an air injection system coupled to each flow electrolysis cell.

In some embodiments, the electrooxidant cocktail includes at least hydroxyl radicals. In some embodiments, the electrooxidant cocktail includes at least ozone, hypochlorite, hydroxyl radicals, hydrogen peroxide and combinations thereof. In some embodiments, the electrooxidation cocktail further includes at least one of monatomic chlorine, ozone free radicals and hydrogen peroxide. After the treated water leaves the electrolysis cell, only chlorine is detected (<1% hypochlorite), as the remainder of the reactive species dissipate. It should be pointed out the electrooxidation cocktail is generally produced using only components present in the wastewater itself and inputted power, without the addition of added chemicals. However, in some embodiments, additional salt may be added to a wastewater source when the native salt levels in the wastewater source are low (e.g., less than about 3000 ppm). As noted above, low salt concentrations may be overcome by operating the electrolytic cells at higher input voltages or decreasing the separation between electrodes. Conversely, electrooxidation may be conducted with greater electrode separation when high salt concentrations are present.

Electrooxidants of an electrooxidation cocktail produced are advantageous in being environmentally benign. The electrooxidants are further advantageous in allowing wastewater purification to occur on a job site generally relying only salt impurities present in the wastewater as a source of the electrooxidants. Accordingly, the need to purchase, transport and store dangerous chemicals is eliminated. As noted above, however, in some embodiments, additional salt may be added to the wastewater source if desired.

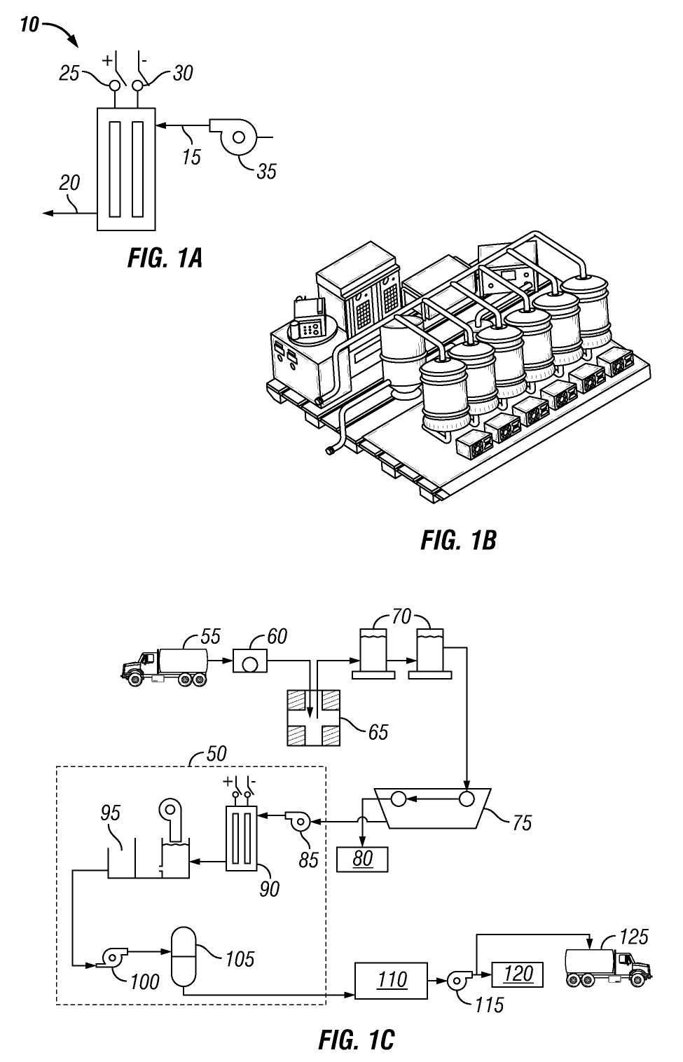

FIG. 1A is an illustrative embodiment of a flow electrolysis cell 10. Flow electrolysis cell 10 may include inlet 15, outlet 20, non-sacrificial anode 25, and cathode 30. A wastewater stream is pumped by pump 35 into flow electrolysis cell 10 through inlet 15. High-voltage electrolysis (i.e., >12 V) may be conducted to perform electrooxidation. As the wastewater stream is flowed through flow electrolysis cell 10, non-sacrificial anode 25 and cathode 30 may be connected to a high voltage power supply, thereby exposing the wastewater to high voltages. Exposure of the wastewater to the high voltages results in formation of at least ozone, hydroxyl radicals, monatomic chlorine and hydrogen peroxide. All of these components are powerful oxidizing agents that efficiently oxidize and substantially remove any biological oxygen demand (BOD), chemical oxygen demand (COD), heavy metals and other organic/inorganic pollutants and bacteria present in the wastewater. The higher the current, the more oxidizing agents produced, including at least ozone, hydroxyl radicals, monatomic chlorine and hydrogen peroxide. Contaminants such as, for example, ammonium sulfides, hydrocarbons, iron, manganese and other heavy metals, are readily oxidized and removed from the wastewater stream. Flow electrolysis cell 10 operates at a relatively high current that allows the wastewater stream to be treated in a single pass through the cell. The contaminants may be removed as a microflocculant after electrooxidation. For example, oils and organics may separate from the wastewater upon oxidation and inorganics may precipitate as a microflocculant. Oxidized organic compounds may also precipitate as a microflocculant in some embodiments. For example, metals are electrochemically oxidized into a metal oxide and then released as a microflocculant sediment. The process safely and efficiently converts the supplied wastewater into an output stream flowing from outlet 20 of flow electrolysis cell 10 having levels of chlorine and mixed oxidants lower than a maximum amounts allowed by environmental regulations. Further, in order to satisfy any potential differences in environmental regulations for different countries, the amount of power provided to flow electrolysis 10 can be adjusted to reduce the amount of oxidizing agents produced.

Microflocculant may be removed from the partially repurified water using a separation means. In some embodiments, the separation means may be a clarifier. The clarifier may be, for example, a dissolved air floatation clarifier. In other embodiments, the separation means may be a centrifuge. Other well known methods of removing microflocculants such as, for example, centrifugation or gravity settling are suitable as well.

In some embodiments, the electrooxidation is performed at low voltage (i.e., an input voltage of less than about 10 V). In other embodiments, the electroxidation is performed at higher voltage (i.e., greater than about 10 V). In some embodiments, non-sacrificial anode 25 is capable of being operated at an input voltage of at least about 1000 W to about 5000 W. In some embodiments, the non-sacrificial anode 25 produces an electrooxidation cocktail including at least ozone, hypochlorite, hydroxyl radicals and hydrogen peroxide upon electrolysis of an aqueous brine solution. In some embodiments, non-sacrificial anode 25 is capable of being continuously operated for at least about 1 month at an input voltage of at least about 12 V.

In some embodiments, an input voltage of the water purification systems is greater than about 12 V. In other embodiments, an input voltage of the water purification systems is greater than about 20 V. In still other embodiments, an input voltage of the water purification systems is greater than about 30 V. In still other embodiments, an input voltage of the water purification systems is greater than about 100 V, and in some embodiments, the input voltage is greater than about 200 V. Higher voltages are advantageous for faster production rates of free radicals and other charged ionic species, as noted above. At higher voltages, larger quantities of water can be purified more rapidly or more polluted samples can be treated more rapidly. Furthermore, at higher voltages, wastewater streams having lower salt concentrations can be effectively purified, because sufficient quantities of oxidant are still produced. In some embodiments, the non-sacrificial anodes of the flow electrolysis cells may be plugged directly into a 110 A or 220 A source.

FIG. 1B is an illustrative embodiment of a water purification system containing multiple flow electrolysis cells linked in parallel. By linking multiple flow electrolysis cells in parallel, water purification systems can purify larger amounts of water and/or purify the water in a shorter time.

In conducting high voltage electrolysis, the power drawn by an electrode may be varied by independently adjusting the input voltage and current. Power is the product of voltage times amperage. In some embodiments, the power drawn by the electrodes of the water purification systems may be greater than about 1000 W. In some embodiments, the power drawn by the electrodes is greater than about 2000 W. In some embodiments, the power drawn by the electrodes is greater than about 3000 W. In some embodiments, the power drawn by the electrodes is between about 1000 W and about 5000 W. In some embodiments, the power drawn by the electrodes is between about 1000 W and about 3000 W. In some embodiments, the power drawn by the electrodes is between about 2000 W and about 3000 W. In some embodiments, the power drawn by the electrodes is between about 1000 W and about 2500 W. In some embodiments, the power drawn by the electrodes is between about 1500 W and about 3000 W. In some embodiments, the power drawn by the electrodes is between about 1500 and about 2500 W. In some embodiments, the power drawn by the electrodes is between about 1500 and about 2000 W. In some embodiments, the power drawn by the electrodes is between about 2000 and about 2500 W. In embodiments wherein multiple electrolytic cells are linked in parallel, each cell can either have the same power draw or be varied independently to have a different power draw. In such embodiments, the total power draw will be the sum of all inputted power. Combinations of voltage and current to produce power draws falling within these ranges and subranges are included within the spirit and scope of the present disclosure. In electrooxidation applications conducted at low voltage (e.g., less than about 10 V), the power drawn by the electrodes may be less than about 1000 W.

FIG. 1C is an illustrative embodiment of water purification system for water purification following hydraulic fracturing of an oil well. As significant quantities of water are used in hydraulic fracturing operations, there is an unmet need in the art for ways to efficient purify recovered well water from the fracturing process, particularly a method that is capable of performing the purification and recovery at the well site. The water purification systems offer 24 hour/day operation and are capable of meeting this unmet need. The purified water leaving the flow electrolysis cell may be further purified, returned for additional fracturing operations, filtered or skimmed to remove sediment or microflocculant, or transferred to a clean water holding pond, truck or tank. Prior to entering water purification system 50, water is housed in water source 55, such as a holding pond, truck, tank or the like. Hydraulic fracturing system 60 may inject fluids into well 65, and the fluids may then be pumped from the well into separation system 70. Separation system 70 may be utilized to separate various fluids and gases from each other. Wastewater from separation system is provided to a skimmer 75 to remove any remaining oil in the wastewater and provide the oil to oil storage 80.

Pump 85 pumps the wastewater from skimmer 75 into water purification system 50. As discussed in other embodiments, flow electrolysis cell 90 produces an electrooxidation cocktail that oxidize and substantially removes BOD, COD, heavy metals and other organic/inorganic pollutants, and bacteria present in the wastewater. Skimmer and settling tank 95 allows particulates, microflocculant, sediment, and the like to be removed from the wastewater. Pump 100 pumps the wastewater into filter 105 to remove any remaining impurities. The water leaving water purification system 50 may be provided to storage 110. The purified water can be pumped from storage to tank or holding pond 120 and/or truck 125. In other embodiments, the purified water may be further purified, returned for additional fracturing operations, filtered or skimmed to remove sediment or microflocculant, or transferred to a clean water holding pond, truck, or tank.

In various embodiments, water purification systems are operated at flow rates ranging from about 35 gal/min to about 500 gal/min. Wastewater may be circulated through the systems in a single pass or recirculated, depending on the purification needs of a particular water source. In addition, flow rates can be adjusted to accommodate the purification needs of a particular water source.

In still further embodiments, water purification methods may include passing the partially repurified water through a suitable filter. For example, in some embodiments, the filter may be a 10 μm filter. In other embodiments, the filter may be a 2 μm filter. In still other embodiments, the filter may be a bag filter.

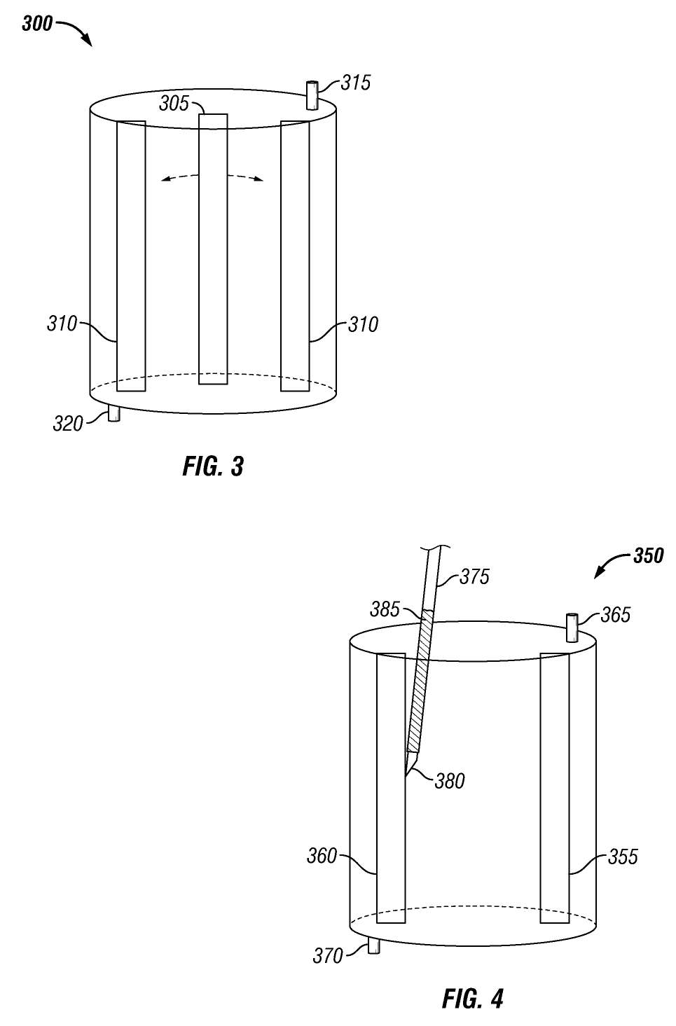

A further advantage of the water purification methods are that pH control of the wastewater source is not particularly critical to provide treatment. At low pH, hypochlorous acid may be produced, but it will break down to form some of the aforementioned species in the electrooxidation cocktail. At higher pH, metal oxidation may become more facile. Although pH control may be advantageous depending on the particular characteristics of the sample, it is not required to adjust the pH to practice the present methods. Furthermore, as disclosed herein cathode-anode separation, such as discussed in FIG. 3, may be used to provide additional control over the electrooxidation in response to the salinity of a wastewater sample.

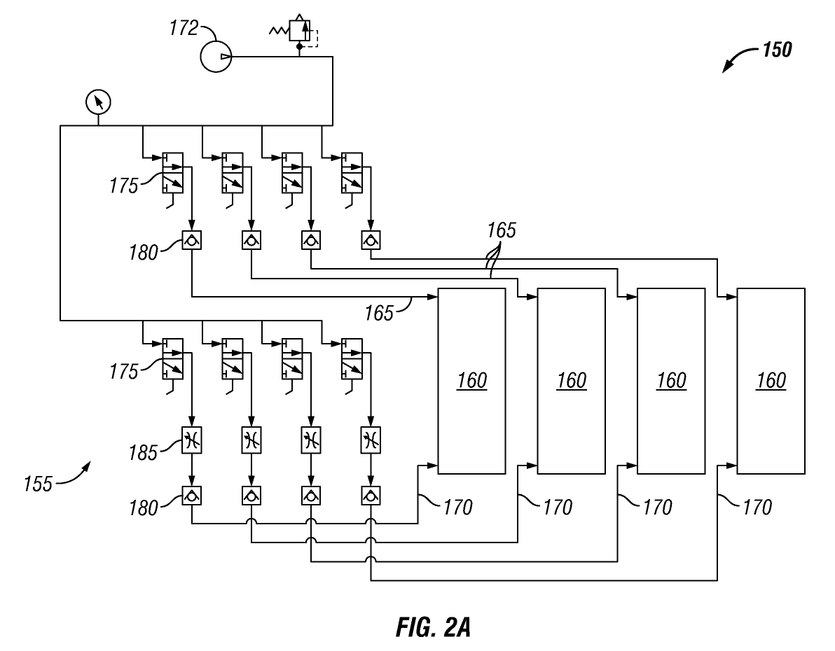

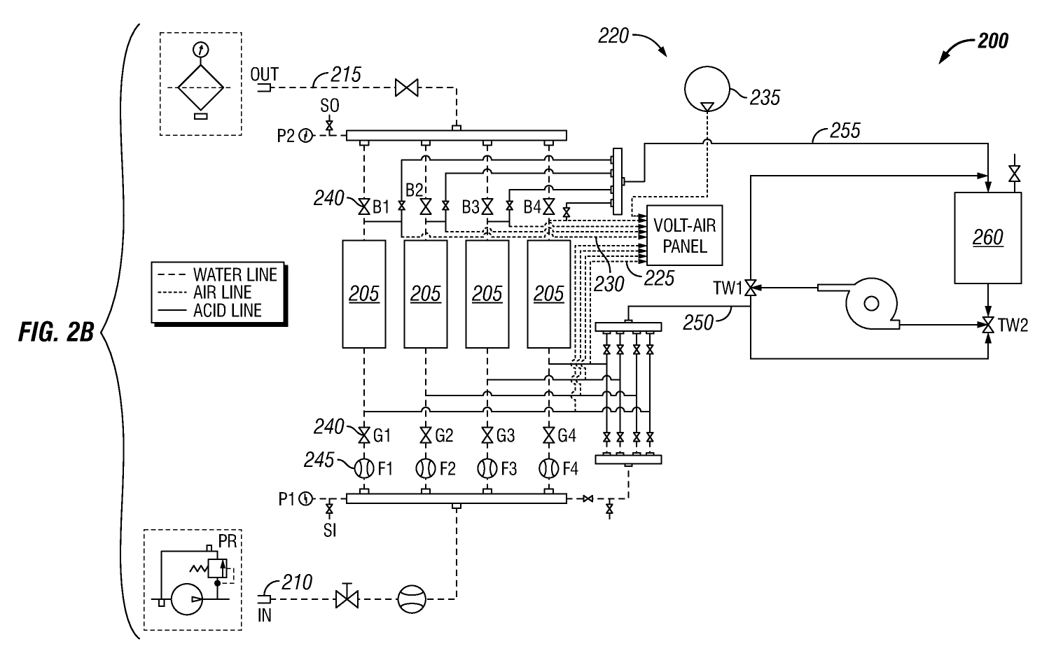

In some embodiments, water purification methods may be advantageous in reducing the turbidity of treated wastewater. For example, the electrooxidants produced by the flow electrolysis cells may react with contaminants present in a water source to produce a microflocculant. Chemical methods for purifying a water stream tend to produce a sludge in the process of removing contaminants from the water source. In contrast, electrooxidants from the flow electrolysis cells advantageously produce a microflocculant, which is typically sand-like in consistency and is easily removed, for example, by means set forth hereinabove. Microflocculants produced by the flow electrolysis cells are easily dealt with as chemical waste, unlike chemically-coagulated sludges which present a more difficult waste disposal problem. It should be noted that a microflocculant will not form upon electrooxidation of all wastewater sources. The particular composition of the wastewater source will govern whether a microflocculant will form in a given instance. It has been observed that the microflocculant, produced by the water purification systems discussed herein, forms more efficiently at higher voltages than in comparison samples treated at lower voltages. Furthermore, air injection, such as discussed in FIGS. 2A and B, aids in formation of the microflocculant. Without being bound by theory or mechanism, it is believed that hydrogen produced during electrooxidation may influence the formation of the microflocculant. In addition to the aforementioned contaminants, other wastewater contaminants may be removed by the water purification systems and methods, as set forth hereinbelow.

Hydrogen sulfide, H₂S, is a colorless, toxic, flammable gas that is responsible for the foul odor of rotten eggs and flatulence. It often results when bacteria break down organic matter in the absence of oxygen, such as in swamps, and sewers (alongside the process of anaerobic digestion). It also occurs in volcanic gases, natural gas and some well waters. It also is present as the part of hydrocarbon streams typical of petroleum recovery sources. Accordingly, hydrogen sulfide can contaminate various water sources and wastewater streams, including those from hydraulic fracturing operations. Hydrogen sulfide is corrosive and renders some steels brittle, leading to sulfide stress cracking, which is a concern in many applications, particularly when handling acid gas and sour crude oil in the oil industry. Hence, removal of hydrogen sulfide is desirable in the art.

The primary method used in the art of removing hydrogen sulfide is the Claus process, which proceeds according to Formula (I).

H₂S+O₂→2S+2H₂O (1)

Other current technology available to remove hydrogen sulfide includes high pressure oxygenation of H₂S solutions and oxidations with ozone and hydrogen peroxide. Therefore, the water purification systems and methods may also be useful for removing hydrogen sulfide from a water source. The electrooxidation cocktail removes hydrogen sulfide not only by oxidizing H₂S to elemental sulfur or sulfur-containing anions (e.g., SO₃⁻, SO₄²⁻), but it also destroys sulfide reducing bacteria (SRB), which may be responsible for production of the hydrogen sulfide in some wastewater sources in the first place. Furthermore, some sulfur-containing organic compounds may be oxidized by the electrooxidation cocktail to reduce their odor (e.g., thioethers oxidized to sulfoxides or sulfones), and further oxidation of the hydrocarbon portion of these molecules may take place as set forth hereinabove to remove them from the purified wastwater.

Electrooxidants may also decompose organic and inorganic compound contaminants giving odor to a wastewater stream without the need for adding any additional chemicals. In contrast, conventional odor removal processes involve addition of chlorine, chlorine dioxide or sodium hypochlorite. Illustrative odor-causing organic compounds that may be removed from a wastewater stream include, for example, phenols, chloramines, compounds from algal blooms (e.g., geosmin and methyl isobomrneon). Inorganic compounds including, for example, ammonia, may be removed to non-toxic levels. Furthermore, the electrooxidants do not form chloramines or cyanogen chloride, both of which cause odor problems.

In some embodiments, the electrolytic cells may also be used for purifying industrial waste water (gray water), treating sewage water, sterilizing medical instruments, surfaces, and certain foods.

FIG. 2A is an illustrative embodiment of a water purification system 150 containing four flow electrolysis cells 160 linked in parallel in which each cell is coupled to an air injection system 155. Details of the electrolysis cells 160 such as the cathode and anode have been omitted for clarity. Water inlet and outlet lines have also been omitted for clarity. Air injection system 155 includes upstream inlet lines 165 and downstream inlet lines 170 on each flow electrolysis cell 160. Air flow from air source 172 to upstream inlet line 165 and downstream inlet line 170 can be independently control with direction valves 175 and check valves 180. In some embodiments, pressure gauge 185 may be included. While pressure gauge 185 is provided along downstream inlet lines 170, in other embodiments, a pressure gauge may be provided along upstream inlet lines 165 or both the upstream 165 and downstream 170 inlet lines.

FIG. 2B is an illustrative embodiment of a water purification system 200, that is coupled to an air injection system 220, containing four flow electrolysis cells 205 linked to wastewater input 210 and output 215. Air injection system 220 is linked to flow electrolysis cells 205 through upstream inlet lines 225 and downstream inlet lines 230. Air flow from air source 235 to upstream inlet line 225 and downstream inlet line 230 can be independently control with valves 240. In some embodiments, pressure gauge 245 may be included. An optional acid input line 250 and acid output line 255 allows acid from tank 260 to be used for cleaning of the electrodes. Prior to entering the water purification system, water is housed in, for example, a holding pond, truck or tank, and then pumped through the system. The purified water leaving the water purification system may be further purified, returned for further use, filtered or skimmed to remove sediment or microflocculant, or transferred to a clean water holding pond, truck or tank.

If a water purification system has a 6,000 barrel per day production capacity, by linking water purification systems in parallel, the production capacity can be increased in multiples of the number of systems linked. For example, four parallel water purification systems have a production capacity of 24,000 barrels per day. Water purification systems may be conveniently housed in the cargo storage area of an 18-wheel trailer. Hence, water purification systems may be transported to a hydraulic fracturing well site for onsite water purification. In some embodiments, water purification systems have a capacity that ranges between about 1,000 and about 80,000 barrels per day.

In some embodiments, the air injection system may be coupled to the top of each flow electrolysis cell. In some embodiments, the air injection system may be coupled to the bottom of each flow electrolysis cell. In still other embodiments, the air injection system may be coupled to both the top and bottom of each flow electrolysis cell.

As aforementioned, inclusion of an air injection system with the water purification systems results in numerous advantages. A first significant advantage is a much higher rate of formation of microflocculant and separation of suspended organic matter. In some embodiments having an air injection system, microflocculant forms in the flow electrolysis cell during electrooxidation. The microflocculant is typically more coarse and settles more readily than does microflocculant produced in the absence of an air injection system. As a result, in some embodiments, the rate of water purification is increased relative to water purification systems not having an air injection system (e.g., 30-50% faster). More ready formation of the microflocculant advantageously allows for higher flow rates to be used in the water purification systems. In some embodiments, the methods further include separating the microflocculant (e.g., in a clarifier).

Typically, air entering upstream of the flow electrolysis cell (e.g., wastewater entering the cell) is used for cleaning of the electrodes and purging of the system. For example, air entering the top of the flow electrolysis cell prevents and breaks free scaling that may form on the electrodes during treatment of wastewater (e.g., calcium deposits). The electrode cleaning offers the opportunity for extended operation times at higher electrode efficiencies. Upstream air injection also enhances the cell reaction by causing turbulent flow, which provides more electrode contact. Finally, upstream air injection may aid in separation of suspended organic matter.

Typically, air entering downstream of the flow electrolysis cell (e.g., wastewater leaving the cell) accomplishes agitation and aeration of the wastewater within the cell. Downstream air injection also may be used to purge the cells, either at the end of a run or for cleaning. The downstream air injection may also enhance formation of a microfloculant in the cell.

Each cell in the water purification system may be operated independently, with air being injected upstream, downstream or both during a run. For example, at any point during a run, some cells may have upstream air injection, some cells may have downstream air injection, and some cells may have both upstream and downstream air injection. Various embodiments have been described with the wastewater and upstream air entering the top of the flow electrolysis cells. However, it is within the spirit and scope of the present disclosure that the flow direction be reversed (i.e., the wastewater adds upstream air entering the bottom of the flow electrolysis cells). The terms “top” and “bottom” are used relative to the direction of the wastewater flow in the flow electrolysis cells. “Top” refers to the entry point of the wastewater and “bottom” refers to the exit point of the wastewater.

FIG. 3 is an illustrative embodiment of a multi-anode flow electrolysis cell 300. Multi-anode flow electrolysis cell 300 contains an adjustable cathode 305 between one or more fixed non-sacrificial anodes 310. For example, in some embodiments, adjustable cathode 305 may be removable to allow a thicker or thinner cathode to substituted. Water inlet 315 and outlet 320 ports are also connected to the flow electrolysis cell. Several multi-anode flow electrolysis cells 300 may be connected in parallel in water purification systems. Purified wastewater leaving the flow electrolysis cell may be further purified, returned for further use, filtered or skimmed to remove sediment or microflocculant, or transferred to a clean water holding pond, truck or tank.

In another embodiment, one non-sacrificial anode 310 is provided with adjustable cathode 305. Adjustable cathode 305 can be adjusted by mechanical means to move the cathode closer to or further away from the non-sacrificial anode 310. For example, a processor coupled to a chemical sensor detecting the salinity level of the wastewater may cause a hydraulic actuator to move adjustable cathode 305 towards or away from non-sacrificial anode 310 depending on the salinity level detected by the chemical sensor.

In various embodiments, the flow electrolysis cells have one or more non-sacrificial anodes, an adjustable cathode (located between the at least two non-sacrificial anodes if there is more than one non-sacrificial anode), an inlet port, and an outlet port. A distance between the adjustable cathode and the non-sacrificial anode(s) is adjusted by a mechanism moving the cathode or by varying a thickness of the adjustable cathode. Low salt concentrations may be overcome by operating the electrolytic cells at higher input voltages or by decreasing the separation between electrodes. Conversely, electrooxidation may be conducted with greater electrode separation when high salt concentrations are present.

In various embodiments, wastewater sources having a salt concentration ranging between about 100 ppm and about 200,000 ppm may be effectively purified by the water purification systems and method discussed herein. In other embodiments, higher salt concentrations also lie within the spirit and scope of the present disclosure. Voltages, flow rates, electrode contact areas (i.e., electrode size), number of electrodes, and electrode separation can be adjusted according to the purification needs of a particular wastewater source. In some embodiments, electrode contact areas may be increased by having more than one anode present. In some embodiments, the electrode thickness may be changed to adjust the electrode separation.

Flow electrolysis cells discussed herein are advantageous over others because the distance between the cathode and the anode may be adjusted. A second advantage flow electrolysis cells is the presence of multiple anodes. The presence of multiple anodes in the flow electrolysis cells allows for greater surface contact area between the electrode surface and the wastewater. The increased surface area results in greater contact time between the wastewater and the electrode while the wastewater is in the cell and accordingly a more efficient electrooxidation results.

The ability to adjust the distance between the cathode and the at least two non-sacrificial anodes is a significant advantage of the flow electrolysis cells. As the cathode and anode are moved further apart, lower quantities of the oxidizing agents noted above are produced upon electrolysis of an aqueous brine solution. Conversely, as the cathode and anode are moved closer together, greater quantities of the oxidizing agents are produced upon electrooxidation. Particularly, at closer cathode-anode separations, higher quantities of ozone and hydroxyl radicals are produced during electrooxidation. By having an adjustable cathode, the cathode-anode separation can be adjusted by moving the adjustable cathode or by placing a second cathode of a different thickness between the anodes in response to a change in salinity of a wastewater source. Accordingly, flow electrolysis cells may be operated at optimal current-voltage parameters, regardless of the salinity of the wastewater source being treated, simply by changing the adjustable cathode. Moving the adjustable cathode by mechanical means or replacing the cathode may be performed automatically or in field operations with minimal labor or equipment downtime involved.

In some embodiments, the adjustable cathode is evenly spaced between at least two non-sacrificial anodes. In other embodiments, the adjustable cathode is unevenly spaced between at least two non-sacrificial anodes. In some embodiments, the methods further include adjusting a distance between the adjustable cathode and at least two non-sacrificial anodes. For example, in some embodiments, adjusting may include replacing the adjustable cathode with another cathode having a different thickness.

In some embodiments, the distance between the adjustable cathode and the one or more non-sacrificial anodes is decreased. In other embodiments, the distance between the adjustable cathode and the one or more non-sacrificial anodes is increased. As discussed hereinabove, cathode-anode separation may be used to control the concentration of oxidizing species produced in response to the salinity of a wastewater source. In some embodiments, the distance between the adjustable cathode and the one or more non-sacrificial anodes is decreased in response to a decrease in salinity of the wastewater source. In other embodirnents, the distance between the adjustable cathode and the one or more non-sacrificial anodes is increased in response to an increase in salinity of the wastewater source.

As a non-limiting example of how cathode thickness can influence the cathode-anode separation and oxidation rate, consider the following scenario in which a cathode having a thickness of 1 cm is placed between two non-sacrificial anodes separated by 3 cm. If the cathode is equally spaced between the two non-sacrificial anodes, each face of the cathode will be 2.5 cm from the faces of the non-sacrificial anodes. In response to a slow rate of oxidation, the cathode-anode separation may be decreased to provide a higher concentration of oxidizing species without adjusting the input power of the flow electrolysis cell or the salinity of the wastewater. In the presently described embodiment, in response to a slow oxidation rate, the cathode would be replaced by a thicker cathode. For instance, replacing the initial cathode with a second cathode having a thickness of 2 cm would decrease the cathode-anode separation to 2 cm. Any range of cathode-anode separation lies within the spirit and scope of the present disclosure.

FIG. 4 is an illustrative embodiment of a flow electrolysis cell 350 having a scraper 375 in movable contact with cathode 360. Flow electrolysis cell 350 has inlet 365 and outlet 370 port allowing wastewater to flow through the cell. Anode 355 and cathode 360 are within the cell. Blade 380 of scraper 375 is in movable contact with cathode 360. Scraper 375 is covered with non-conductive coating 385 except where blade 375 is in movable contact with cathode 360.

During treatment of wastewater, a significant deposit buildup (e.g., calcium deposits) can be deposited on the cathode. This deposit buildup hinders the formation of oxidizing species and reduces the efficiency of the flow electrolysis cells for water purification. Even though the electrodes of the flow electrolysis cells are suitable for continuous high voltage electrooxidation, buildup of residues or deposits on the electrodes can result in downtime to clean the electrodes. Cleaning may be performed by mechanical means to keep the electrodes free of deposits and operating at peak efficiency. Embodiments of flow electrolysis cells described herein may include a mechanical scraper to remove these residues and deposits to allow continuous or near continuous operation of the flow electrolysis cells without the need for potentially costly downtime required for electrode cleaning.

In some embodiments, a mechanical scraper is in movable contact with the cathode to accomplish removal of deposits from the cathode. In some embodiments, the mechanical scraper includes a blade such as, for example a stainless steel blade. In some embodiments, the blade is operable to remove any deposits that form on the cathode. Mechanical scrapers in the form of a blade are particularly advantageous for cleaning the cathodes because the metal-metal contact of both the cathode and anode with the scraper is not damaging to the electrode itself. Brushes used in the art for electrode cleaning are not as efficient at keeping the electrode clean and also have the possibility of scratching or otherwise damaging the electrodes. In some embodiments, an edge of the blade is in movable contact with the cathode. In some embodiments, the portion of the blade or mechanical scraper not in contact with the cathode is coated with a non-conductive coating (e.g., a polymer). The non-conductive coating allows the scraper or blade to be inserted into the flow electrolysis cell while the cell is operating to clean the cathode in situ without requiring system shutdown. Without the non-conductive coating, the scraper might otherwise be damaged by the electrooxidation conditions.

In some embodiments, scraping occurs while electrolyzing is occurring. In some embodiments, the scraping is performed manually. For example, in response to a visual assessment of deposit buildup scraping may be initiated. In other embodiments, scraping may be performed automatically. For example, in response to an assay showing increased contaminants in purified wastewater, scraping may be initiated in response to an increased concentration of contaminants. In other embodiments, scraping may be initiated by automated means in response to a visual or detected buildup of deposits on the cathode. Automation of the mechanical scraper may be conducted by standard robotics techniques known to those of ordinary skill in the art.

In the embodiments discussed herein, the various features of the water purification systems and methods discussed herein may be combined, substituted, replaced, and/or the like. For example, a flow electrolysis cell may utilize any suitable combination of adjustable anodes, multiple non-sacrificial anodes, air injection, and/or a scraper. Further, such flow electrolysis cells may be suitable for use in any water purification system or method discussed herein or known in the art.

### EXPERIMENTAL EXAMPLES

The following experimental examples are included to demonstrate particular aspects of the water purification systems and methods. It should be appreciated by those of skill in the art that the methods described in the examples that follow merely represent exemplary embodiments of the water purification systems and methods. Those of ordinary skill in the art should appreciate that many changes can be made in the specific embodiments described and still obtain a like or similar result without departing from the spirit and scope of the water purification systems and methods.

### Example 1

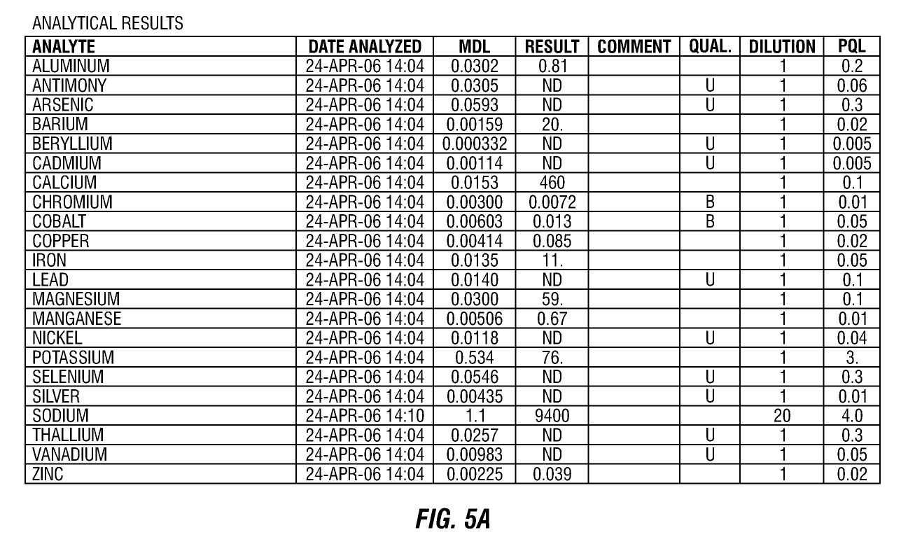

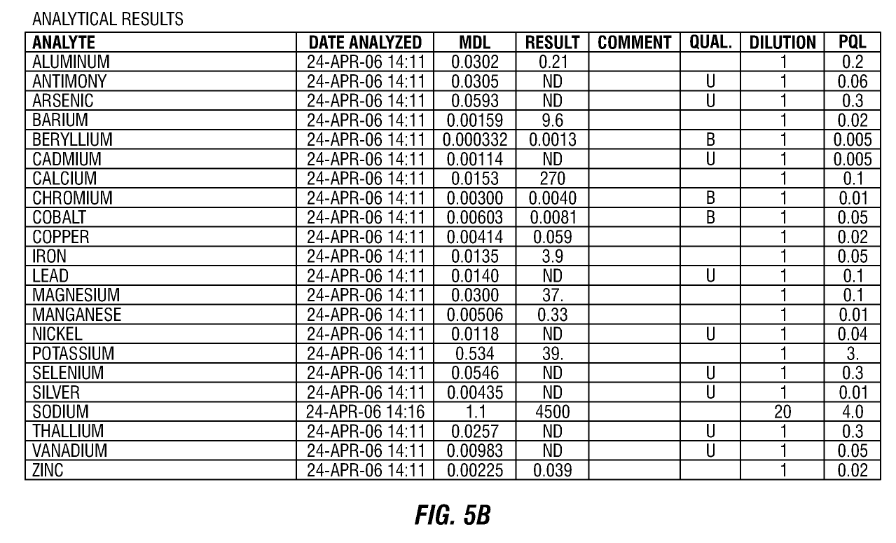

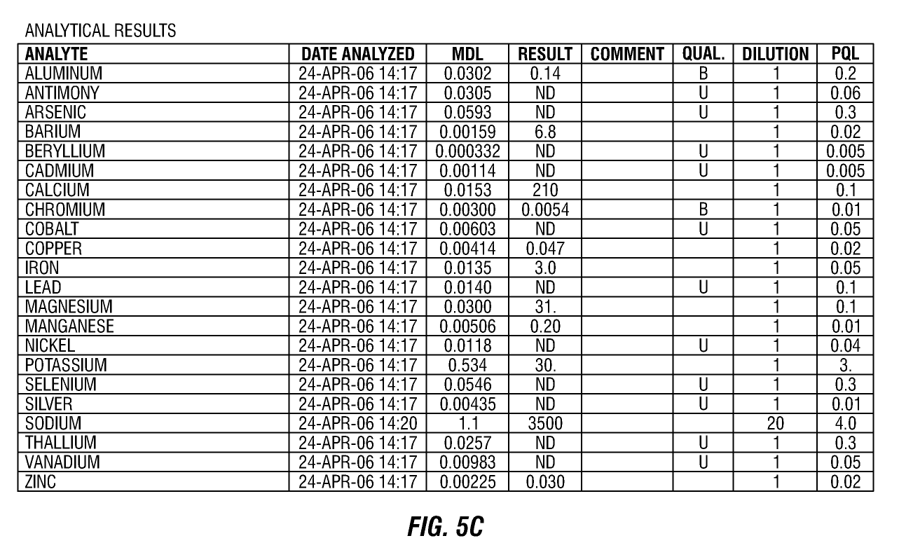

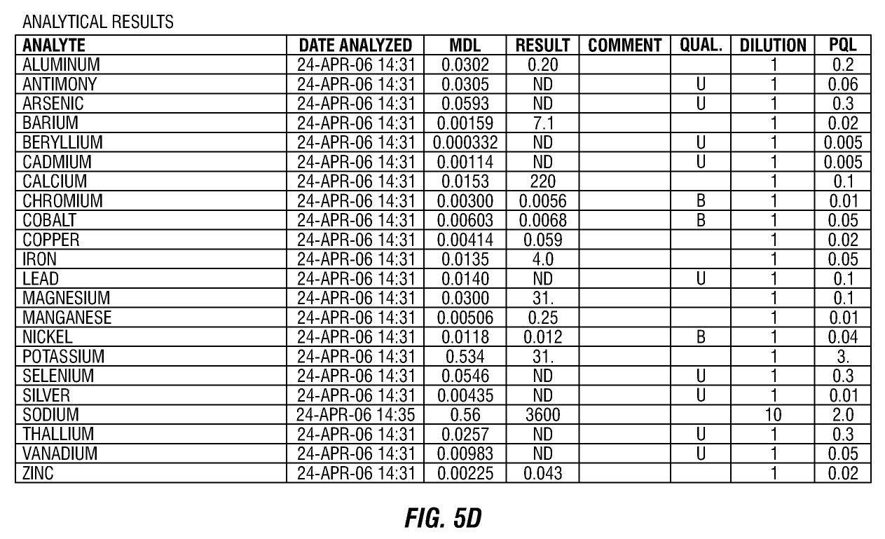

Illustrative Results from Treatment of a Wastewater Sample. A sample of brackish water from a drilling site was processed with the electrochemical cell. FIG. 5A shows analytical results for metals before treatment. FIG. 5B shows analytical results for metals after one treatment. FIG. 5C shows analytical results for metals after two treatments, and FIG. 5D shows analytical results for metals after three treatments. In general, the concentration of analyzed metals decreased upon subsequent treatments, and a particularly large drop was observed in going from the untreated sample to the once-treated sample.

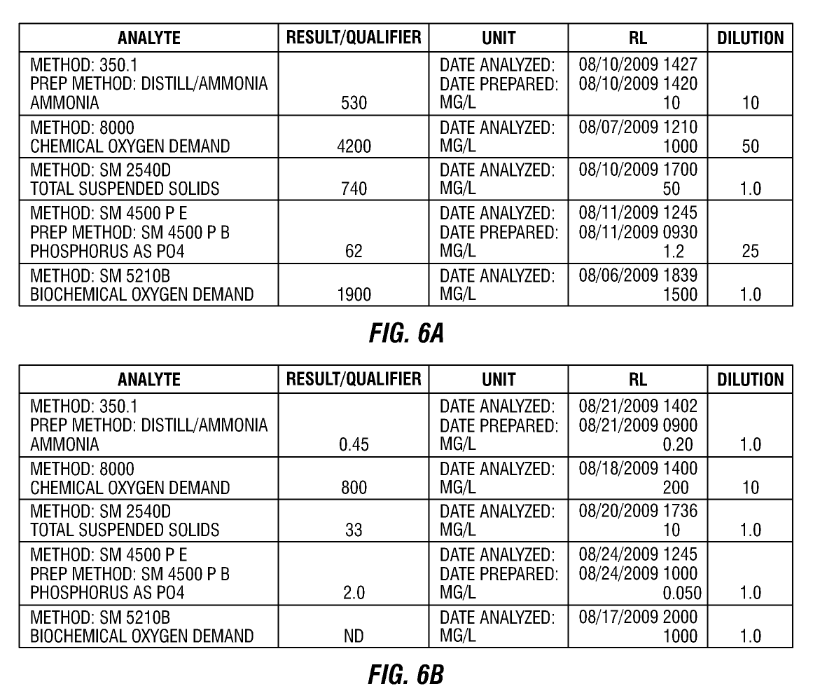

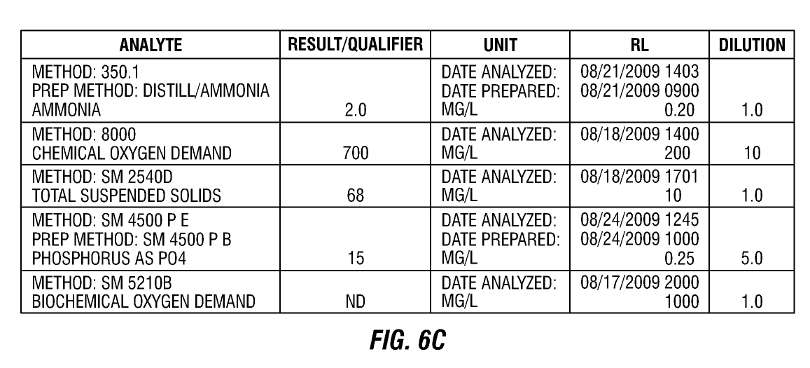

FIG. 6A shows analytical results for ammonia analysis, chemical oxygen demand, total suspended solids, phosphate and biological oxygen demand before treatment. FIG. 6B shows analytical results after one treatment, and FIG. 6C shows analytical results after two treatments. As shown in the experimental data, all parameters decreased sharply after one treatment. Biological oxygen demand was decreased to non-detectable levels after one treatment.

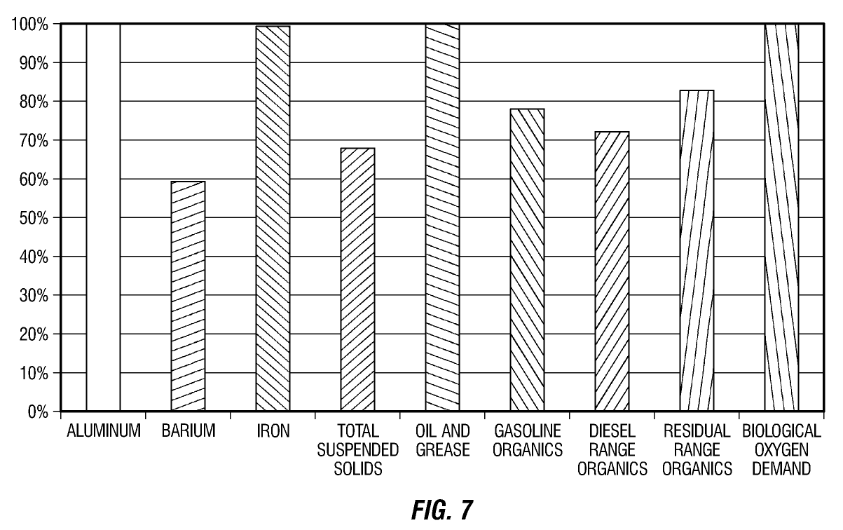

FIG. 7 is an illustrative embodiment of a chart summarizing analytical results of a wastewater sample. As is clearly evident from the results shown, significant purification took place in the purified samples.

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure, which is defined in the following claims.

From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure, which is defined in the following claims.

What is claimed is the following:

1. A water purification system comprising:
at least one flow electrolysis cell, each cell comprising
an input for receiving wastewater;
a cathode;
a non-sacrificial anode, wherein the non-sacrificial anode is capable of being operated at an input power of at least 1000 W to form electrooxidation cocktail, and the electrooxidation cocktail treats the wastewater to form purified water at a flow rate of at least 20 gallons per minute; and
an output for outputting purified water.

2. The water purification system of claim 1, further comprising a clarifier operable for removing a microflocculant.

3. The water purification system of claim 2, wherein the clarifier is a dissolved air floatation clarifier.

4. The water purification system of claim 1, further comprising an air injection system coupled to the flow electrolysis cell, wherein the air injection system aerates the wastewater in the flow electrolysis cell.

5. The water purification system of claim 4, wherein the air injection system is coupled to the top of the flow electrolysis cell.

6. The water purification system of claim 4, wherein the air injection system is coupled to the bottom of the flow electrolysis cell.

7. The water purification system of claim 1, further comprising an actuator coupled to the cathode, wherein the actuator adjust a predetermined distance between the cathode and the non-sacrificial anode.

8. The water purification system of claim 1, further comprising a mechanical scraper in movable contact with the cathode.

9. The flow electrolysis cell of claim 8, wherein the mechanical scraper comprises a blade, wherein an edge of the blade is in movable contact with the cathode.

10. The flow electrolysis cell of claim 8, wherein the portion of the blade not in contact with the cathode is coated with a non-conductive coating.

11. A method for purifying water, said method comprising:
providing wastewater to at least one flow electrolysis cell;
electrolyzing the wastewater using the flow electrolysis cell, said cell comprising a cathode and a non-sacrificial anode, and the non-sacrificial anode is operated at an input power of at least 1000 W to form an electrooxidation cocktail; and
outputting purified water from the flow electrolysis cell at a flow rate of at least 20 gallons per minute.

12. The method of claim 11, further comprising adding salt to the wastewater.

13. The method of claim 11, wherein the non-sacrificial anode is capable of being continuously operated at a voltage of at least about 12 V over a time period of at least about one month.

14. The method of claim 1, further comprising:
oxidizing at least a portion of any contaminants present in the wastewater source with the electrooxidation cocktail to form the purified water, wherein the oxidizing produces a microflocculant; and
removing the microflocculant from the purified water.

15. The method of claim 11, aerating the wastewater source while electrolyzing in each of the at least one flow electrolysis cells using an air injection system, wherein the air injection system is coupled to each of the at least one flow electrolysis cells.

16. The method of claim 15, wherein the aerating takes place from the top of each flow electrolysis cell.

17. The method of claim 15, wherein the aerating takes place from the bottom of each flow electrolysis cell.

18. The method of claim 11, further comprising adjusting a distance between the adjustable cathode and the non-sacrificial anode.

20. The method of claim 18 wherein the distance between the adjustable cathode and the non-sacrificial anode is decreased.

21. The method of claim 18, wherein the distance between the adjustable cathode and the non-sacrificial anode is increased.

22. The method of claim 1, further comprising:
scraping the cathode with the mechanical scraper to remove any deposits formations on the cathode.

23. The method of claim 22, wherein the scraping occurs while electrolyzing is occurring.
